(19) United States
(12) Patent Application Publication
(10) Pub. No.: US 2008/0068627 A1
(43) Pub. Date: Mar. 20, 2008

(54) Method and apparatus for determining and saving a location of a section of an item of content

(76) Inventors: Matt E. Hart, Lunenburg, MA (US); Arno Grbac, West Newton, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/523,849

(22) Filed: Sep. 20, 2006

(51) Int. Cl. G06F 15/00

(52) U.S. Cl. 358/1.9

(57) ABSTRACT

One embodiment of the present invention provides a system for determining and saving a location of a section of an item of content. During operation, the system receives a section of a content map associated with the item of content from an input device, wherein the content map is located on the same physical medium as the item of content, and wherein the section of the content map is collocated with the section of the item of content, whereby the input device can be positioned in close proximity to the section of the item of content to receive a corresponding section of the content map. The system then uses the section of the content map to determine the location of the section of the item of content. Then, the system saves the location of the section of the item of content at the client. Note that saving the location of the section of the item of content facilitates subsequently retrieving the section of the item of content.

### BACKGROUND

### Related Art

While performing research, users typically examine a multitude of resources, such as books or journal articles. Often, the user will want to refer back to specific sections of these resources at a later date and time. To do so, the user usually attempts to remember the location of these sections, or uses notes, such as sticky-notes, to mark the locations of the sections for future reference. However, trying to remember the locations of many sections can become difficult as the number of sections increases. Furthermore, using sticky-notes to tag sections can become messy and impractical as the number of sections the user tags increases. Moreover, if the user does not own the resources, both of these methods may be infeasible because the user may need to return the resources to their owners before getting an opportunity to refer back to the resources.

One solution to the above-mentioned problem is for the user to transcribe the sections of the resources that the user considers important. However, transcribing is a tedious and time-consuming task. Furthermore, this solution does not work well for non-textual data, such as images.

Another solution is to photocopy the sections of the resources that are relevant to the user. However, if the user needs to refer back to many sections, the user may have trouble locating the sections to photocopy. Furthermore, the user may find it difficult to remember why certain sections were important enough to photocopy without the use of sticky-notes.

Hence, if a user performing a research project has many resources to examine, the user may find it difficult to recall the location of important sections of resources. Furthermore, the user may find it difficult to remember what the user was thinking about when the user identified a specific section. Furthermore, a significant time-gap between viewings of the resource by the user can exacerbate this problem.

### SUMMARY

One embodiment of the present invention provides a system for determining and saving a location of a section of an item of content. During operation, the system receives a section of a content map associated with the item of content from an input device, wherein the content map is located on the same physical medium as the item of content, and wherein the section of the content map is collocated with the section of the item of content, whereby the input device can be positioned in close proximity to the section of the item of content to receive a corresponding section of the content map. The system then uses the

section of the content map to determine the location of the section of the item of content. Then, the system saves the location of the section of the item of content at the client. Note that saving the location of the section of the item of content facilitates subsequently retrieving the section of the item of content.

In a variation on this embodiment, the system receives a content identifier from the input device, wherein the content identifier identifies the item of content. The system then uses the content identifier to obtain an index of the content map for the item of content, wherein the index of the content map associates sections of the content map with sections of the item of content.

In a variation on this embodiment, the system receives meta-data at the client which is relevant to the section of the item of content. The system then associates the meta-data with the section of the item of content.

In a further variation, the meta-data can include: an identifier for the section of the item of content; a user-defined note associated with the section of the item of content; a third-party-defined note associated with the section of the item of content; a subset of the data included in the section of the item of content; and a second section of the item of content.

In a further variation, receiving the meta-data at the client can involve: receiving the meta-data from a user; receiving the meta-data from a database; and receiving the meta-data from a service.

In a further variation, the system saves the meta-data on the database.

In a variation on this embodiment, the system receives a search term from a user. Next, the system searches the item of content for a second section of the item of content that relates to the search term. The system then presents the second section of the item of content to the user.

In a further variation, presenting the second section of the item of content to the user involves presenting meta-data which is relevant to the second section of the item of content.

In a variation on this embodiment, the system saves the section of the item of content on a database.

### BRIEF DESCRIPTION OF THE FIGURES

FIG. 1 illustrates a computing environment in accordance with an embodiment of the present invention.

FIG. 2 illustrates a content-section entry window in accordance with an embodiment of the present invention.

FIG. 3 illustrates a search window in accordance with an embodiment of the present invention.

FIG. 4 presents a flow chart illustrating the process of saving a location of a section of an item of content in accordance with an embodiment of the present invention.

FIG. 5 presents a flow chart illustrating the process of searching for a location of a section of an item of content in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention includes a portable client, such as a personal digital assistant (PDA), that is capable of saving a location of a section of an item of content, wherein the item of content is printed on digital paper. Note that digital paper is any paper that includes patterns, digital pen marks, such as Anoto digital pen marks. (Note that Anoto is a trademark of Anoto AB, which may be registered in the United States and/or other countries.) This patterned paper enables a user to write with ink on the paper and then to use a digital pen to interpret and upload the handwriting to a client. In this embodiment, the item of content can include digital pen marks, which identify sections in the item of content. Furthermore, the portable client can include a digital pen that a user can use to select and highlight sections of an item of content.

In one embodiment of the present invention, using a digital pen, a user selects a section of an item of content that the user considers important. The digital pen then sends a section of a content-map collocated with the section of the item of content to the portable client to facilitate in determining the location of the section of the item of content. Next, the user can associate meta-data, such as a user-defined note reminding the user why the section of the item of content is important, with the location of the section of the item of content. Note that the meta-data can include meta-data that the portable client obtains from a database, such as a transcription of content included in the section of the item of content. The user can then instruct the portable client to save the location of the section of the item of content and the associated meta-data. Thus, a user can refer back to the section of the item of content without using sticky-notes or remembering precisely what was important about the section of the item of content.

In one embodiment of the present invention, meta-data can include a second section of the item of content and meta-data associated with the second section of the item of content. Furthermore, meta-data can include a section of a second item of content and meta-data associated with the section of the second item of content. This embodiment enables the user to aggregate multiple sections of an item of content. Furthermore, this embodiment enables the user to aggregate multiple sections from multiple items of content.

In one embodiment of the present invention, the meta-data can be specified by: the user; another user; a database; or a third-party, such as a data-research service. This embodiment facilitates the sharing of research by enabling the user to view sections of an item of content and corresponding meta-data that a second user or a third-party has identified.

In one embodiment of the present invention, the user can use an input device to tag information on a web-page that the user wants to refer to at a later time. This embodiment enables the user to view information from multiple web-pages in the future without having to navigate to the web-pages again.

### Computing Environment

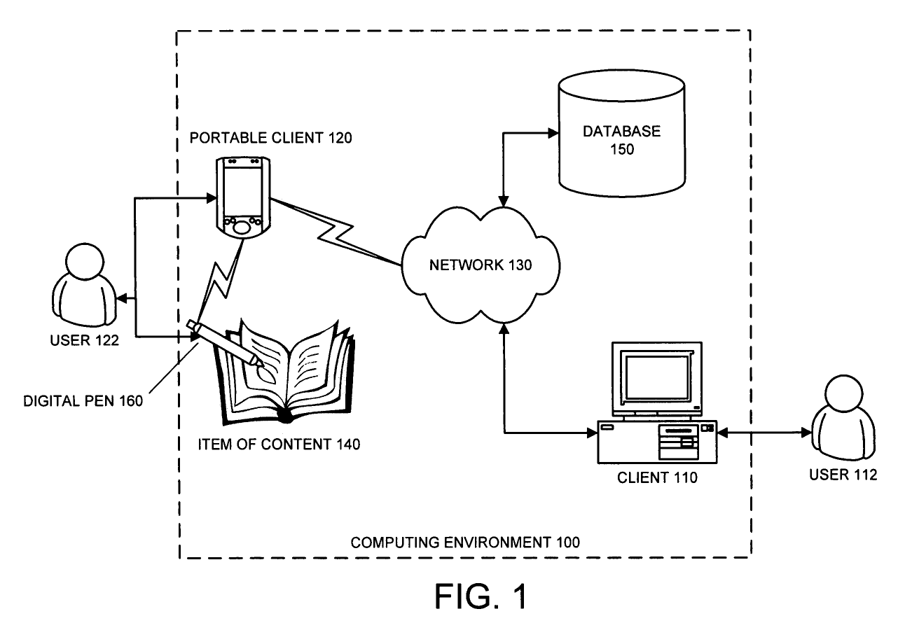

FIG. 1 illustrates a computing environment 100 in accordance with an embodiment of the present invention. Computing environment 100 includes a number of computer systems. These computer systems can generally include any type of computer system based on a microprocessor, a mainframe computer, a digital signal processor, a portable computing device, a personal organizer, a device controller, or a computational engine within an appliance. More specifically, computing environment 100 includes client 110, portable client 120, network 130, item of content 140, database 150, and digital pen 160.

Client 110 and portable client 120 can generally include any node on a network including computational capability and including a mechanism for communicating across the network. Note that portable client 120 can communicate over a wireless communication channel with network 130 as is illustrated in FIG. 1.

Network 130 can generally include any type of wired or wireless communication channel capable of coupling together computing nodes. This includes, but is not limited to, a local area network, a wide area network, or a combination of networks. In one embodiment of the present invention, network 130 comprises the Internet.

Item of content 140 can generally include any media that can be printed on digital paper, such as: books, magazines, newspapers, journals, and any other printable media known to those familiar with the art.

In one embodiment of the present invention, item of content 140 can include a digital book, or an e-book, and any other form of electronic media known to those familiar with the art.

In one embodiment of the present invention, item of content 140 can also include a Radio Frequency Identification (RFID) tag.

Database 150 can generally include any type of system for storing data in non-volatile storage. This includes, but is not limited to, systems based upon magnetic, optical, and magneto-optical storage devices, as well as storage devices based on flash memory and/or battery-backed up memory.

Digital pen 160 can generally include any mechanism capable of scanning and uploading data printed on digital paper, or included in a digital book or an e-book to an electronic device. Note that digital pen 160 can communicate over a wireless communication channel with portable client 120 as is illustrated in FIG. 1.

In one embodiment of the present invention, consider the scenario where user 122 is reading item of content 140 in preparation for writing a thesis on the health benefits of sailing. Suppose that user 122 reads some information that could possibly invalidate the premise of the thesis, but user 122 does not presently have time to verify the information. Using digital pen 160, user 122 can click on a digital mark located on the title page of item of content 140. This causes digital pen 160 to send a content-identifier associated with item of content 140 to portable client 120. Portable client 120 then uses the content-identifier to identify an index associated with item of content 140. This index associates sections of a content-map associated with item of content 140 with sections of item of content 140. After portable client 120 identifies the index, user 122 uses digital pen 160 to click on a section of the content-map collocated with the section of interest in item of content 140. In response to the click on the section of the content-map, digital pen 160 sends the section of the content-map to portable client 120. Then, portable client 120 uses the section of the content map and the index to determine the location of the section of interest in item of content 140. At this point, user 122 can associate any additional information, meta-data, that user 122 wants portable client 120 to store along with the location of the section of interest in item of content 140. This meta-data can include: an identifier for the section of interest in item of content 140; a user-defined note created by user 122; a third-party-defined note; a subset of the data included in the section of interest in item of content 140; a second section in item of content 140; and a section of another item of content. Note that the second section in item of content 140 and the section of another item of content are hereinafter referred to as related meta-data.

In one embodiment of the present invention, related meta-data can include meta-data defined by a second user, such as user 112, which is associated with the section of interest in item of content 140.

In one embodiment of the present invention, user 122 can request that portable client 120 upload the location of the section of interest in item of content 140 and the meta-data that user 122 associated with the section of interest in item of content 140 to database 150. In this embodiment, user 122 can decide to make the location and the meta-data public or private. This embodiment enables user 112 to use client 110 to search database 150 for the location of the section of interest in item of content 140 and the meta-data user 122 associated with the section of interest in item of content 140.

### Content-Section Entry Window

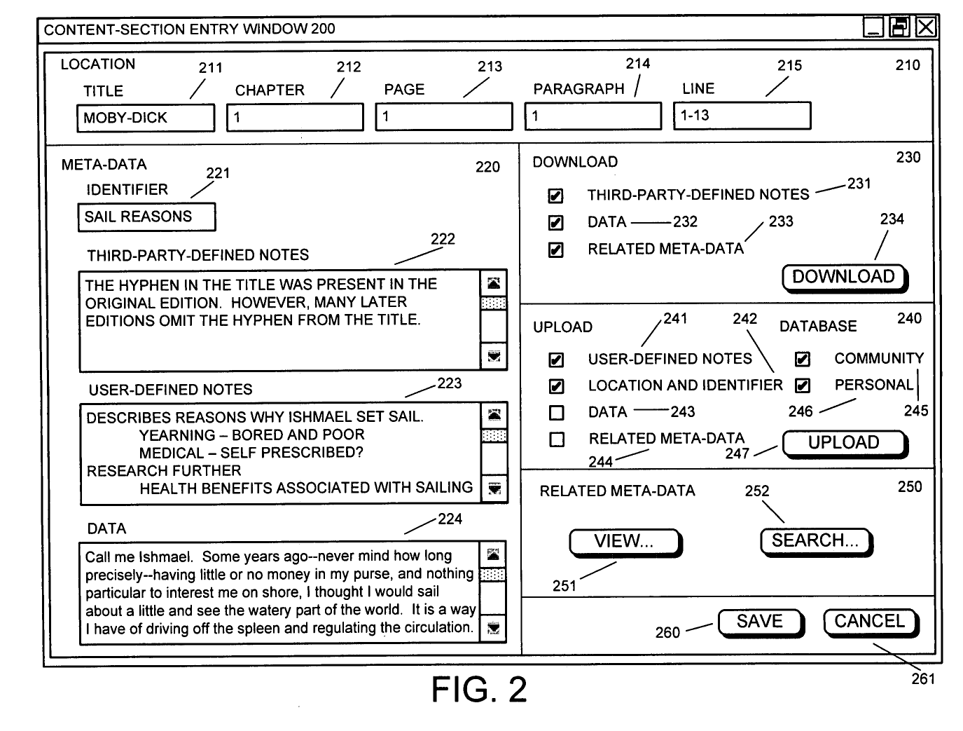

FIG. 2 illustrates a content-section entry window 200 in accordance with an embodiment of the present invention. Using content-section entry window 200, user 122 specifies meta-data that user 122 wants portable client 120 to associate with a section in item of content 140. User 122 then instructs portable client 120 to store the location of the section and the meta-data on portable client 120, a personal database, or a community database. Note that a personal database is a database that only user 122 can access, and a community database is a database that multiple users can access. Moreover, content-section entry window 200 includes location panel 210, meta-data panel 220, download panel 230, upload panel 240, and related meta-data panel 250.

In one embodiment of the present invention, location panel 210 specifies the location of a content-section that user 122 has identified by using digital pen 160 to click on a section of the content map associated with item of content 140. In this embodiment, location-panel 210 includes location-information, such as title 211, chapter 212, page 213, paragraph 214, and line 215. Note that chapter 212, page 213, paragraph 214, and line 215 can specify a range of values. Furthermore, note that the range of values is not limited to a contiguous range of values. This enables user 122 to aggregate the locations of several sections in item of content 140 into one content-section entry stored on portable client 120.

In one embodiment of the present invention, portable client 120 bases the type of location-information to present to user 122 in location-panel 210 on the content identifier received from digital pen 160. For example, if the content identifier is associated with a magazine, location panel 210 will include an article title in place of chapter 212.

In one embodiment of the present invention, meta-data panel 220 can include meta-data that user 122 wants portable client 120 to associate with the location of the section of item of content 140. Moreover, meta-data panel 220 includes identifier 221, third-party-defined notes 222, user-defined notes 223, and data 224.

In one embodiment of the present invention, portable client 120 can associate text that user 122 enters into identifier 221 with a section in item of content 140. This text is an “identifier” for the location of the content-section in item of content 140 that user 122 is saving on portable client 120.

In one embodiment of the present invention, third-party-defined notes 222 can include information related to item of content 140 and/or the content-section that a third-party, such as a publisher, has associated with item of content 140 and/or the content-section. For example, the publisher may include information conveying the history of changes in the title of item of content 140.

In one embodiment of the present invention, user 122 can enter into user-defined notes 223 any notes that user 122 wants portable client 120 to associate with the location of the section of item of content 140. For example, user 122 can enter a note describing the information in the section of item of content 140 referred to by the associated section of the content map, or user 122 can enter a note reminding user 122 about new ideas to research.

In one embodiment of the present invention, in response to a request by user 122, portable client 120 includes in data 224 a sub-section of the data in the section of item of content 140. Note that this sub-section of data can include all of the data referred to by the section of item of content 140. Furthermore, note that the data can include text, images, music, video, and any other type of data that can be included in item of content 140.

In one embodiment of the present invention, user 122 can use download panel 230 to specify meta-data that user 122 wants portable client 120 to download from database 150. Note that database 150 can be a personal database, a community database, -or a combination of a personal database and a community database. Using download panel 230, user 122 can select third-party-defined notes 231, data 232, or related meta-data 233, and then can click on download button 234 to instruct portable client 120 to download the selections from database 150. Note that by clicking on download button 234, user 122 can instruct portable client 120 to associate the downloaded content with the location of the section of item of content 140.

In one embodiment of the present invention, user 122 can use upload panel 240 to specify portions of content-section entry window 200 that user 122 wants portable client 120 to upload to database 150. User 122 can also use upload panel 240 to specify whether user 122 wants to upload the content-section entry to a community database, a personal database, or both a community database and a personal database. For example, using upload panel 240, user 122 can select user-defined notes 241, location and identifier 242, data 243, and related meta-data 244, and can then click on upload button 247 to instruct portable client 120 to upload the information specified in user-defined notes 223, location panel 210 and identifier 221, data 224, and the related meta-data to database 150. Note that user 122 can select community 245, personal 246, or both community 245 and personal 246 to indicate which database is to receive the specified information.

In one embodiment of the present invention, related meta-data panel 250 includes view button 251, and search button 252. By clicking on view button 251, user 122 can see a list of related meta-data that is associated with the location of the section of item of content 140. Related meta-data can include: a location of a second section of item of content 140 and meta-data user 122 associated with the second section; a location of a section of a second item of content and meta-data user 122 associated with the section of the second item of content; a location of a second section of item of content-1-40 and meta-data user 112 associated with the second section; a location of a section of a second item of content and meta-data user 112 associated with the section of the second item of content; and any other locations of a section of an item of content and any other meta-data that user 122 requests portable client 120 to associate with the location of the section of item of content 140 specified in content-section entry window 200.

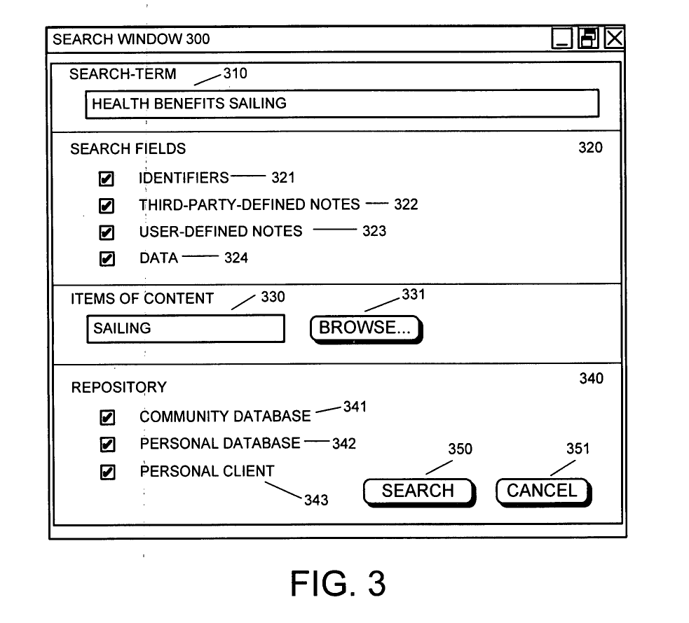

In one embodiment of the present invention, clicking on search button 252 instructs portable client 120 to open a search window. User 122 can use the search window to find related meta-data that user 122 wants to link to the location of the section in item of content 140 specified in content-section entry window 200. The search window is described in more detail below with reference to FIG. 3.

User 122 can click on save button 260 to save the content-section entry to portable client 120.

User 122 can click on cancel button 261 to close content-section entry window 200 without saving the content-section entry to portable client 120. Note that if user 122 clicks on upload button 247 before clicking on cancel button 261, database 150 will receive the content-section entry before portable client 120 discards the content-section entry. However, user 122 will not be able to view the content-section entry on portable client 120 without first downloading the content-section entry from database 150.

### Search Window

FIG. 3 illustrates a search window 300 in accordance with an embodiment of the present invention. User 122 can use search window 300 to instruct portable client 120 to search for a saved location of a section in item of content 140 and any associated meta-data stored on database 150, portable client 120, or both database 150 and portable client 120. Moreover, search window 300 includes search-term field 310, search fields panel 320, items of content field 330, and repository panel 340.

In one embodiment of the present invention, user 122 can enter a search-term into search-term field 310. Portable client 120 can then use the search-term entered in search-term field 310 to search a database stored on portable client 120 for a set of locations of sections in a set of items of content associated with the search-term. Note that portable client 120 can also search database 150 for the set locations.

In one embodiment of the present invention, user 122 can select which content-section entry fields for portable client 120 to search by selecting a set of field-types from search fields panel 320. The field-types can include identifiers 321, third-party-defined notes 322, user-defined notes 323, and data 324.

In one embodiment of the present invention, user 122 can specify an item of content, or a set of items of content in items of content field 330 for portable client 120 to search. Note that the set of items of content can be specified by: title, genre, subject, keyword, author, or any other method for specifying a set of items of content known to those familiar with the art. In this embodiment, user 122 clicks on browse button 331 to obtain a list of items of content that user 122 can select for portable client 120 to search.

In one embodiment of the present invention, user 122 can select from repository panel 340 which databases portable client 120 is to search for the search-term. In this embodiment, user 122 can select community database option 341, personal database option 342, personal client option 343, or a combination of community database option 341, personal database option 342, and personal client option 343.

User 122 can then click on search button 350 to instruct personal client 120 to execute the search. In one embodiment of the present invention, in response to user 122 clicking on search button 350, portable client 120 can present a list of search-results to user 122. The search-results can include: locations of sections in item of content 140, meta-data, and related meta-data. In this embodiment, user 122 can select a search-result to view or to associate with a location of a section in item of content 140 as related meta-data.

User 122 can click on cancel button 351 to close search window 300.

### Saving a Location of a Section of an Item of Content

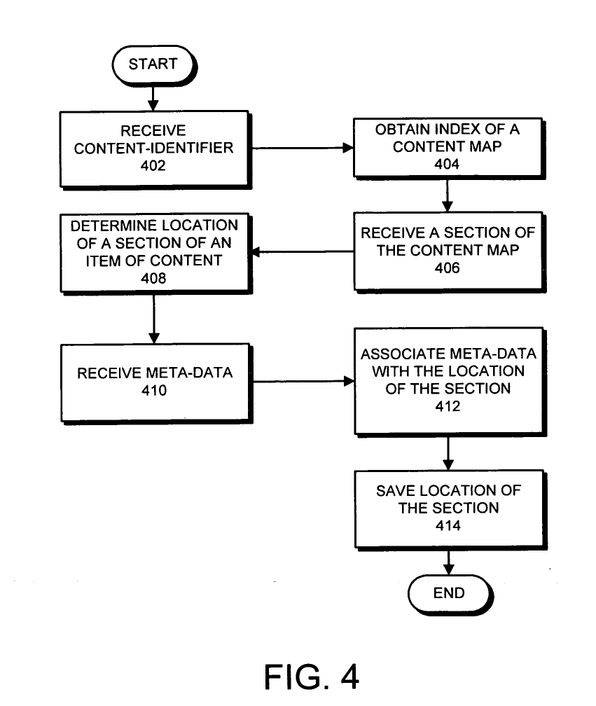

FIG. 4 presents a flow chart illustrating the process of saving a location of a section of an item of content 140 in accordance with an embodiment of the present invention. The process begins when portable client 120 receives a content-identifier, which identifies item of content 140, from digital pen 160 (step 402). Note that user 122 can use digital pen 160 to obtain the content-identifier by scanning a barcode, reading an RFID tag, reading a digital mark included in item of content 140, or by any other possible method for obtaining a content-identifier. In one embodiment of the present invention, user 122 identifies item of content 140 to portable client 120 by selecting item of content 140 from a list, by providing a content-identifier to portable client 120, or by any other possible method for identifying item of content 140 to portable client 120.

Next, portable client 120 uses the content identifier to obtain an index of a content map associated with item of content 140 (step 404). Note that the index associates sections of the content map with sections of item of content 140. Furthermore, the content map is located on the same physical medium as item of content 140. Moreover, sections of the content map are collocated with corresponding sections of item of content 140. Thus, user 122 can obtain a section of the content map by placing digital pen 160 in close proximity to the corresponding section of item of content 140.

In one embodiment of the present invention, portable client 120 can obtain the index from database 150.

Portable client 120 then receives a section of the content map from digital pen 160 (step 406). User 122 can use digital pen 160 to obtain the section of the content map by: clicking on a digital mark associated with the content map; highlighting the section of the content map; or by any other possible method for obtaining the section of the content map.

Next, portable client 120 uses the section of the content map to determine from the index a location associated with a section of item of content 140 (step 408). Note that the location determined from the index specifies where the section is located in item of content 140. Portable client 120 then receives meta-data from user 122 (step 410). This meta-data can include: an identifier for the location of the section in item of content 140; a third-party-defined note; a user-defined note; and a subset of the data included in the section of item of content 140, wherein the subset of data can be the complete set of data specified by the location of the section in item of content 140. Note that the third-party-defined note can include any information that is associated with item of content 140 by a third-party, such as item of content 140's publisher. Furthermore, note that the subset of data can include: text, images, music files, video files, Braille, and any other possible data-type that can be included in item of content 140. Moreover, note that portable client 120 or user 122 can obtain the subset of data by: scanning the data with digital pen 160; communicating with database 150; or any other possible method for obtaining the subset of data. In one embodiment of the present invention, portable client 120 contacts database 150 to obtain the meta-data from database 150.

In one embodiment of the present invention, the meta-data includes related meta-data, which can include: meta-data from a second user, such as user 112; meta-data from a third-party, such as a commercial-research service; a second section associated with item of content 140 and any meta-data associated with the second section; and a section associated with a second item of content and any meta-data associated with the section associated with the second item of content.

Portable client 120 then associates the meta-data with the location of the section of item of content 140 (step 412). Next, portable client 120 saves the location of the section of item of content 140 (step 414). Note that this can include saving the meta-data associated with the location of the section of item of content 140.

In one embodiment of the present invention, portable client 120 can save the location of the section of item of content 140 and any associated meta-data on database 150. In this embodiment, portable client 120 can store the location of the section of item of content 140 and any associated meta-data as private, public, or public to a subset of users of database 150.

In one embodiment of the present invention, the location of the section of item of content 140 can be a section of a web-page. In this embodiment, if user 122 instructs portable client 120 to save the section of the web-page, portable client 120 can remove extraneous data from the section of the web-page, such as advertisements, before saving the section of the web-page. Searching for a Location of a Section of an Item of Content

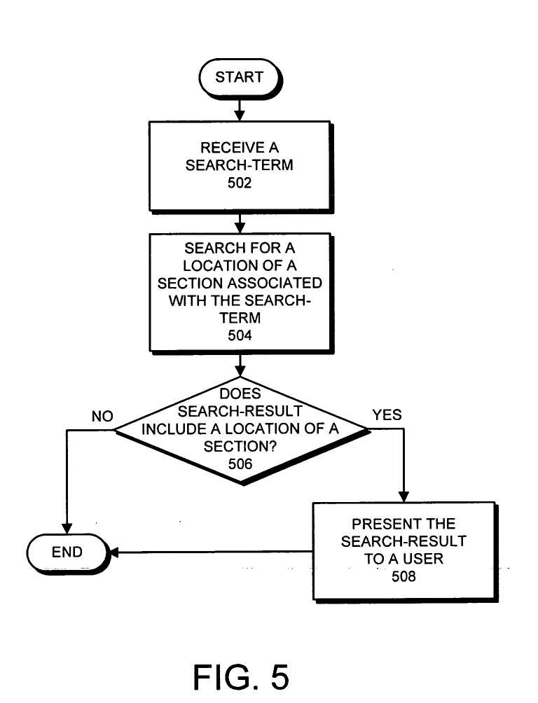

FIG. 5 presents a flow chart illustrating the process of searching for a location of a section of an item of content 140 in accordance with an embodiment of the present invention. The process begins when portable client 120 receives a search-term (step 502). This search-term can include: an identifier; meta-data, or a subset of meta-data; related meta-data, or a subset of related meta-data; and any term that user 122 wants portable client 120 to search for.

Next, portable client 120 searches for a location of a section of item of content 140 associated with the search-term to obtain a search-result (step 504). This can involve: searching portable client 120, searching database 150, and searching any client, server, database, or storage-medium that is capable of storing a location of a section of item of content 140.

Portable client 120 then determines if the search-result includes at least one location of a section of an item of content (step 506). If so, portable client 120 presents the search-result to user 122 (step 508). In one embodiment of the present invention, presenting the search-result to user 122 involves presenting: a location of a section of item of content 140; meta-data associated with the location of the section of item of content 140; and related meta-data associated with location of the section of item of content 140.

In one embodiment of the present invention, portable client 120 can search for any occurrence of the search term and is not limited to searching for the occurrence of the search term in item of content 140. In this embodiment, portable client 120 presents to user 122 any location of a section of an item of content that includes the search-term.

In one embodiment of the present invention, user 122 can search for a location of a section of item of content 140 by using any client, server, or search-system that is capable of searching a storage-medium for a location of a section of item of content 140.

In one embodiment of the present invention, user 122 can use a browser, such as a web-browser, to search for a location of a section of item of content 140. In this embodiment, user 122 can view the search results in the browser.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining and saving a location of a section of an item of content, the method comprising:
receiving a section of a content map associated with the item of content from an input device, wherein the content map is located on the same physical medium as the item of content, and wherein the section of the content map is collocated with the section of the item of content, whereby the input device can be positioned in close proximity to the section of the item of content to receive a corresponding section of the content map;
using the section of the content map to determine the location of the section of the item of content;
saving the location of the section of the item of content at the client; and
wherein saving the location of the section of the item of content facilitates subsequently retrieving the section of the item of content.

2. The method of claim 1, further comprising:
receiving a content identifier from the input device, wherein the content identifier identifies the item of content; and
using the content identifier to obtain an index of the content map for the item of content, wherein the index of the content map associates sections of the content map with sections of the item of content.

3. The method of claim 1, further comprising:
receiving meta-data at the client which is relevant to the section of the item of content; and
associating the meta-data with the section of the item of content.

4. The method of claim 3, wherein the meta-data can include:
an identifier for the section of the item of content;
a user-defined note associated with the section of the item of content;
a third-party-defined note associated with the section of the item of content;
a subset of the data included in the section of the item of content; and
a second section of the item of content.

5. The method of claim 3, wherein receiving the meta-data at the client can involve:
receiving the meta-data from a user;
receiving the meta-data from a database; and
receiving the meta-data from a service.

6. The method of claim 5, further comprising saving the meta-data on the database.

7. The method of claim 1, further comprising:
receiving a search term from a user;
searching the item of content for a second section of the item of content that is related to the search term; and
presenting the second section of the item of content to the user.

8. The method of claim 7, wherein presenting the second section of the item of content to the user involves presenting meta-data which is relevant to the second section of the item of content.

9. The method of claim 1, further comprising saving the section of the item of content on a database.

10. A computer-readable storage medium storing instructions that when executed by a computer cause the computer to perform a method for determining and saving a location of a section of an item of content, the method comprising:
receiving a section of a content map associated with the item of content from an input device, wherein the content map is located on the same physical medium as the item of content, and wherein the section of the content map is collocated with the section of the item of content, whereby the input device can be positioned in close proximity to the section of the item of content to receive a corresponding section of the content map;
using the section of the content map to determine the location of the section of the item of content;
saving the location of the section of the item of content at the client; and
wherein saving the location of the section of the item of content facilitates subsequently retrieving the section of the item of content.

11. The computer-readable storage medium of claim 10, the method further comprising:
receiving a content identifier from the input device, wherein the content identifier identifies the item of content; and
using the content identifier to obtain an index of the content map for the item of content, wherein the index of the content map associates sections of the content map with sections of the item of content.

12. The computer-readable storage medium of claim 10, the method further comprising:
receiving meta-data at the client which is relevant to the section of the item of content; and
associating the meta-data with the section of the item of content.

13. The computer-readable storage medium of claim 12, wherein the meta-data can include:
an identifier for the section of the item of content;
a user-defined note associated with the section of the item of content;
a third-party-defined note associated with the section of the item of content;
a subset of the data included in the section of the item of content; and
a second section of the item of content.

14. The computer-readable storage medium of claim 12, wherein receiving the meta-data at the client can involve:
receiving the meta-data from a user;
receiving the meta-data from a database; and
receiving the meta-data from a service.

15. The computer-readable storage medium of claim 14, the method further comprising saving the meta-data on the database.

16. The computer-readable storage medium of claim 10, the method further comprising:
receiving a search term from a user;
searching the item of content for a second section of the item of content that is related to the search term; and
presenting the second section of the item of content to the user.

17. The computer-readable storage medium of claim 16, wherein presenting the second section of the item of content to the user involves presenting meta-data which is relevant to the second section of the item of content.

18. The computer-readable storage medium of claim 10, the method further comprising saving the section of the item of content on a database.

19. An apparatus for determining and saving a location of a section of an item of content, comprising:
a receiving mechanism configured to receive a section of a content map associated with the item of content from an input device, wherein the content map is located on the same physical medium as the item of content, and wherein the section of the content map is collocated with the section of the item of content, whereby the input device can be positioned in close proximity to the section of the item of content to receive a corresponding section of the content map;
a determination mechanism configured to use the section of the content map to determine the location of the section of the item of content; and
a saving mechanism configured to save the location of the section of the item of content at the client, wherein saving the location of the section of the item of content facilitates subsequently retrieving the section of the item of content.

20. The apparatus of claim 19, further comprising:
a receiving mechanism configured to receive a content identifier from the input device, wherein the content identifier identifies the item of content; and
a retrieval mechanism configured to use the content identifier to obtain an index of the content map for the item of content, wherein the index of the content map associates sections of the content map with sections of the item of content.

21. The apparatus of claim 19, further comprising:
a receiving mechanism configured to receive meta-data at the client which is relevant to the section of the item of content; and
an associating mechanism configured to associate the meta-data with the section of the item of content.

22. The apparatus of claim 21, wherein the receiving mechanism can be further configured to:
receive the meta-data from a user;
receive the meta-data from a database; and receive the meta-data from a service.

23. The apparatus of claim 22, further comprising a saving mechanism configured to save the meta-data on the database.

24. The apparatus of claim 19, further comprising:
a receiving mechanism configured to receive a search term from a user;
a search mechanism configured to search the item of content for a second section of the item of content that is related to the search term; and
a presentation mechanism configured to present the second section of the item of content to the user.

25. The apparatus of claim 24, wherein the presentation mechanism is further configured to present meta-data which is relevant to the second section of the item of content to the user.

26. The apparatus of claim 19, further comprising a saving mechanism configured to save the section of the item of content on a database.
